(19) United States
(12) Patent Application Publication
(10) Pub. No.: US 2003/0118769 A1
(43) Pub. Date: Jun. 26, 2003

(54) Release liner and pressure-sensitive adhesive sheet with release liner

(75) Inventors: Yoshikazu Tanaka, Ibarak-shi (JP); Shigeki Muta, Ibaraki-shi (JP); Hideki Akamatsu, Ibaraki-shi (JP)

Correspondence Address: SUGHRUE MION, PLLC, 2100 PENNSYLVANIA AVENUE, N.W., WASHINGTON, DC, 20037, US

(73) Assignee: NITTO DENKO CORPORATION

(21) Appl. No.: 10/303,796

(22) Filed: Nov. 26, 2002

(30) Foreign Application Priority Data
Dec. 14, 2001 (JP) P2001-381379

(51) Int. Cl. B32B 9/00

(52) U.S. Cl. 428/40.1; 428/219

(57) ABSTRACT

A release liner which is effective in diminishing cutting blade abrasion and has satisfactory tear strength includes a base material layer and a release agent layer disposed over at least one side of the base material layer, wherein the maximum cut resistance force imposed on a cutting blade when the release liner is cut therewith is 230 N/30 mm or lower and the release liner has a tear strength of 0.6 N or higher.

### FIELD OF THE INVENTION

The present invention relates to a release liner and a pressure-sensitive adhesive sheet with a release liner. The release liner and pressure-sensitive adhesive sheet with a release liner according to the invention are useful when cutting processing such as cutting or punching is necessary.

### BACKGROUND OF THE INVENTION

Pressure-sensitive adhesive sheets are presently being used in various ways in a wide range of fields including not only nameplate fixing, interior automotive trim parts, office uses, and general domestic uses but also the optical, electronic, and electrical fields. There are many cases where pressure-sensitive adhesive sheets are processed into various sizes and shapes by cutting, punching, or the like to obtain products according to such applications. When a large quantity of pressure-sensitive adhesive sheets are required to be thus processed by cutting, punching, or the like, the cutting blade used for the cutting or punching abrades to reduce the working efficiency. In particular, in adhesive tapes for fixing flexible printed wiring boards or reinforcement plates therefor, a hard layer such as, e.g., a clay coat layer is frequently formed on the surface of the base material layer of the release liner in order to impart heat resistance and moisture resistance. In this case, cutting blade abrasion is more apt to proceed. Namely, to diminish the abrasion of blades for use in cutting or punching is an important property of pressure-sensitive adhesive sheets.

At present, there is an expedient for diminishing the blade abrasion, which comprises designing a release liner so that the base material layer thereof has a reduced thickness or basis weight. However, reducing the thickness or basis weight of the base material layer results in a decrease in the tear strength of the release liner. Because of this, when the release liner is peeled from the pressure-sensitive adhesive sheet, the release liner breaks, resulting in a decrease in working efficiency. As described above, there generally is a trade-off relationship between the diminution of cutting blade abrasion and the improvement of tear strength.

### SUMMARY OF THE INVENTION

An aim of the invention is, under these circumstances, to provide a release liner which is effective in diminishing cutting blade abrasion and has satisfactory tear strength. Another aim of the invention is to provide a pressure-sensitive adhesive sheet with a release liner, which employs the release liner.

The present inventors made intensive investigations in order to overcome the problems described above. As a result, they have found that those aims can be accomplished with the release liner and pressure-sensitive adhesive sheet described below. The invention has been thus completed.

Namely, the invention relates to a release liner which comprises a base material layer and a release agent layer disposed over at least one side of the base material layer, wherein the maximum cut resistance force imposed on a cutting blade when the release liner is cut therewith is 230 N/30 mm or lower and the release liner has a tear strength of 0.6 N or higher.

In the invention described above, the release liner has been regulated so that the maximum cut resistance force imposed on the blade when the release liner is processed by cutting, punching, or the like is 230 N/30 mm or lower, whereby the blade can be inhibited from abrading during cutting processing. The lower the maximum cutting resistance force, the more the release liner is preferred. The maximum cutting resistance force is preferably 200 N/30 mm or lower, more preferably 180 N/30 mm or lower. However, from the standpoint of the strength of the release liner, the maximum cutting resistance force is preferably regulated usually to 50 N/30 mm or higher. In the invention described above, the release liner has further been regulated so as to have a tear strength of 0.6 N or higher, whereby the release liner can be prevented from breaking during peeling. The higher the tear strength, the more the release liner is preferred. The tear strength is 0.6 N or higher, more preferably 0.8 N or higher. However, from the standpoint of processability, the tear strength is preferably regulated usually to 2 N or lower.

The release liner is especially useful when the release agent layer has been disposed through a coat layer. Release liners having a hard coat layer, e.g., a clay coat layer, are apt to abrade cutting blades. However, the release liner of the invention inhibits the cutting blade from abrading and has satisfactory tear strength.

The release liner preferably has been regulated so that the base material layer has a density of from 0.3 to 0.85 g/cm³. In case where the thickness or basis weight of the base material layer is reduced in order to diminish the abrasion of cutting blades caused by the release liner, there is a trade-off relationship between abrasion diminution and tear strength. However, regulating the base material layer so as to have a reduced density tends to result in an increased tear strength even when the base material has the same basis weight. Consequently, this release liner can reconcile the inhibition of cutting blade abrasion and the prevention of tear breakage during peeling. From the standpoint of inhibiting the abrasion of cutting blades, the density of the base material layer is regulated to preferably 0.85 g/cm³ or lower, more preferably 0.8 g/cm³ or lower. On the other hand, lower densities of the base material layer tend to result in impaired stiffness and reduced working efficiency. Consequently, the density of the base material layer is regulated to preferably 0.3 g/cm³ or higher, more preferably 0.5 g/cm³ or higher.

The invention further relates to a pressure-sensitive adhesive sheet with a release liner, wherein the release agent layer of the release liner described above has been superposed on the pressure-sensitive adhesive layer of a pressure-sensitive adhesive sheet.

### BRIEF DESCRIPTION OF THE DRAWINGS

FIG. 1 is a sectional view illustrating one embodiment of the release liner according to the invention.

FIG. 2 is a sectional view illustrating one embodiment of the pressure-sensitive adhesive sheet with a release liner according to the invention.

FIG. 3 is a sectional view illustrating another embodiment of the pressure-sensitive adhesive sheet with a release liner according to the invention.

FIG. 4 is a front view of an apparatus for measuring the maximum cut resistance forces of release liners.

FIG. 5 illustrates the cutting part of the apparatus for measuring maximum cut resistance force.

FIG. 6 illustrates the cutting part of an apparatus used for abrasion evaluation.

FIG. 7 shows the results of an examination of a cutting blade which had abraded.

### DESCRIPTION OF REFERENCE NUMERALS

1: release liner

11: base material layer

12: coat layer

13: release agent layer

2: pressure-sensitive adhesive sheet

21: pressure-sensitive adhesive layer

22: pressure-sensitive adhesive sheet base material

3: pressure-sensitive adhesive sheet with a release liner

### DETAILED DESCRIPTION OF THE INVENTION

The release liner and pressure-sensitive adhesive sheet with a release liner according to the invention will be explained below by reference to the accompanying drawings.

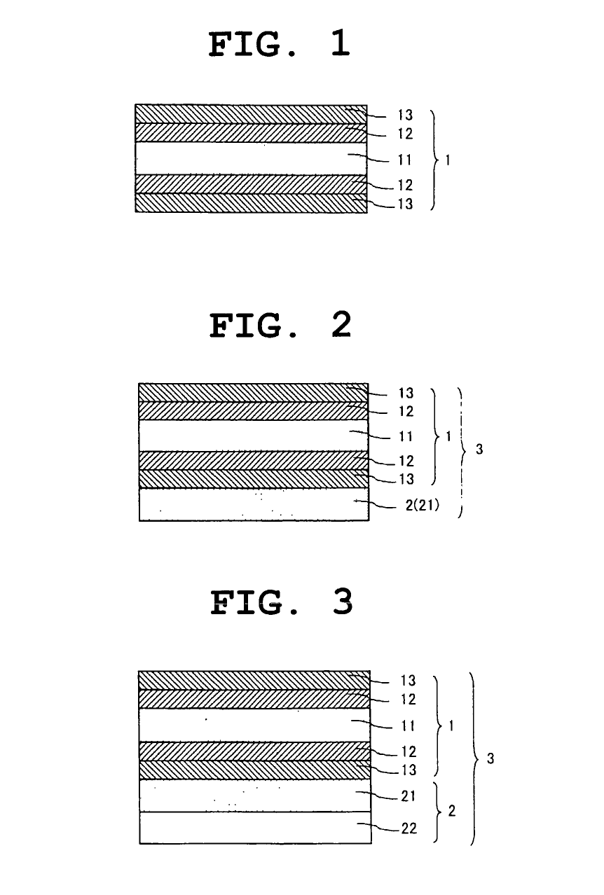

The release liner of the invention comprises a base material layer and a release agent layer disposed over at least one side of the base material layer. The release agent layer can be disposed on one or each side through a coat layer. FIG. 1 shows an embodiment of a release liner 1, which comprises a base material 11 and a release agent layer 13 disposed on each side of the base material 11 through a coat layer 12.

FIGS. 2 and 3 each show an embodiment of a pressure-sensitive adhesive sheet with a release liner 3, in which the release agent layer 13 disposed on one side of the release liner 1 has been superposed on a pressure-sensitive adhesive layer 21 of a pressure-sensitive adhesive sheet 2. In the embodiment shown in FIG. 2, the pressure-sensitive adhesive layer 21 by itself serves as the pressure-sensitive adhesive sheet 2. In the embodiment shown in FIG. 3, the pressure-sensitive adhesive sheet 2 employed is one composed of a base material 22 and the pressure-sensitive adhesive layer 21 formed thereon. Although the pressure-sensitive adhesive sheet 2 in each of FIGS. 2 and 3 has been superposed only on one side of the release liner 1, the pressure-sensitive adhesive sheet 2 can be superposed on each side of the release liner 1.

As the material constituting the base material layer, any of papers and plastic films ordinarily used in release liners can be employed without particular limitations. Examples of the papers include wood-free paper, glassine paper, kraft paper, Clupak paper, and the like. Examples of the plastic films include poly(ethylene terephthalate), poly(butylene terephthalate), poly(ethylene nitrate), rigid poly(vinyl chloride), polypropylene, and the like. The base material layer may be made of a blend of any desired two or more materials or may be a laminate comprising a combination of any desired two or more materials.

As stated above, the base material layer preferably is one regulated so as to have a density of from 0.3 to 0.85 g/cm³. In the case where a base material layer consisting of a paper is to be used, a method usable for regulating the base material layer density to a value within that range is, for example, to increase the proportion of needle-leaved conifer pulp (NBKP) in a mixed pulp comprising needle-leaved conifer pulp and broad-leaved conifer pulp (LBKP). Although the basis weight thereof is not particularly limited, it is from 30 to 150 g/m², preferably from 40 to 120 g/m², from the standpoint of working efficiency. The thickness of the base material layer is not particularly limited as long as it is in the range of generally about from 1 to 5,000 μm.

As a release agent for use in forming the release agent layer can be used any of ordinary release agents for release liners without particular limitations. Examples thereof include silicone release agents, fluorochemical release agents, long-chain alkyl acrylate release agents, long-chain-alkyl-modified polymeric release agents, and the like. These release agents are used as an emulsion type, solvent-based type, or solventless type. Preferred of these release agents from the standpoint of release quality are silicone release agents. Although the thickness of the release agent layer is not particularly limited, it is usually about from 0.01 to 5 μm.

For forming the coat layer, any of the coating materials ordinarily used for release liners can be employed without particular limitations. Examples thereof include polyamides such as nylon-6, nylon-6,6, and partly aromatic polyamides, flexible poly(vinyl chloride), poly(vinylidene chloride), low-density polyethylene, linear low-density polyethylene, high-density polyethylene, poly(4-methyl-l-pentene), and the like. The coat layer may be one obtained by applying a clay consisting mainly of an inorganic material or the like together with an organic binder. Examples of the inorganic material include inorganic oxides, hydroxides, carbonic acid salts, sulfuric acid salts, silicic acid salts, titanic acid salts, boric acid salts, carbides, nitrides, and borides, carbons, and the like. Preferred of these are silica, alumina, mica, and the like. Examples of the organic binder include various binders such as isocyanate, acrylic, vinyl chloride, and epoxy binders. The coat layer may be a blend or laminate comprising any desired combination of two or more of these. The coat layer may be formed in any desired manner. The thickness thereof is not particularly limited as long as it is in the range of usually about from 1 to 1,000 μm.

Methods for producing the release liner of the invention are not particularly limited. For example, the release liner can be produced by forming a release agent layer on one or each side of a paper or plastic film as a base material layer optionally after forming a coat layer.

The pressure-sensitive adhesive sheet with a release liner according to the invention is one in which the release agent layer of the release liner has been superposed on the pressure-sensitive adhesive layer of a pressure-sensitive adhesive sheet. The pressure-sensitive adhesive sheet may consist of a pressure-sensitive adhesive layer alone, or may be composed of a base material and a pressure-sensitive adhesive layer formed thereon.

The pressure-sensitive adhesive layer is not particularly limited as long as it is one ordinarily used as a pressure-sensitive adhesive layer for pressure-sensitive adhesive sheets. A base polymer of, for example, the acrylic, urethane, rubber, or polyester type or another type is selected, according to the intended use, as the pressure-sensitive adhesive for forming the pressure-sensitive adhesive layer. In the case where a pressure-sensitive adhesive layer is to be formed through photopolymerization, a photopolymerizable compound, e.g., a (meth)acrylate compound, is incorporated. A crosslinking agent is suitably incorporated into the pressure-sensitive adhesive. Furthermore, a tackifier, plasticizer, softener, filler, etc. are suitably incorporated. The thickness of the pressure-sensitive adhesive layer is usually about from 3 to 5,000 μm.

The base material of the pressure-sensitive adhesive sheet is not particularly limited as long as it is one ordinarily used in pressure-sensitive adhesive sheets. Examples of the base material of the pressure-sensitive adhesive sheet include plastic films such as polyester films, nonwoven fabrics, foam sheets, and the like. The thickness of the base material is usually about from 10 to 1,000 μm.

In producing the pressure-sensitive adhesive sheet with a release liner according to the invention, a pressure-sensitive adhesive layer can be directly formed on the release agent layer of the release liner of the invention. Alternatively, the target pressure-sensitive adhesive sheet can be produced by separately forming a pressure-sensitive adhesive layer on a release liner and transferring the adhesive layer to the release liner of the invention. It is also possible to apply the base material of a pressure-sensitive adhesive sheet to the pressure-sensitive adhesive layer formed on the release liner. Furthermore, the pressure-sensitive adhesive sheet with a release liner according to the invention can be produced by separately forming a pressure-sensitive adhesive layer on a base material to obtain a pressure-sensitive adhesive sheet and applying this adhesive sheet to the release agent layer of the release liner of the invention. The pressure-sensitive adhesive sheet with a release liner according to the invention preferably has a peel force of usually about from 0.05 to 10 N/50 mm when the release liner is peeled from the pressure-sensitive adhesive layer at 180° and 300 mm/min (23° C.).

The invention will be explained below by reference to Examples, but the invention should not be construed as being limited to these Examples.

### EXAMPLE 1

(Production of Release Liner)

Silica was fixed with an isocyanate binder to each side of wood-free paper having a thickness of 93 μm, basis weight of 68.0 g/m², and density of 0.73 g/cm³ to form a clay coat layer (3 μm). A silicone layer (0.8 μm) was further formed on each side to obtain a release liner.

(Production of Pressure-Sensitive Adhesive Sheet with Release Liner)

From a double-faced adhesive tape (No. 500, manufactured by Nitto Denko Crop.) were removed the release liners. The release liner produced above was applied to each side of the exposed adhesive layer to thereby produce a pressure-sensitive adhesive sheet with a release liner.

### EXAMPLE 2

Silica was fixed with an isocyanate binder to each side of wood-free paper having a thickness of 86 μm, basis weight of 68.7 g/m², and density of 0.80 g/cm³ to form a clay coat layer (3 μm). A silicone layer (0.8 μm) was further formed on each side to obtain a release liner.

(Production of Pressure-Sensitive Adhesive Sheet with Release Liner)

From a double-faced adhesive tape (No. 500, manufactured by Nitto Denko Crop.) were removed the release liners. The release liner produced above was applied to each side of the exposed adhesive layer to thereby produce a pressure-sensitive adhesive sheet with a release liner.

### COMPARATIVE EXAMPLE 1

Silica was fixed with an isocyanate binder to each side of wood-free paper having a thickness of 113 μm, basis weight of 99.0 g/m², and density of 0.88 g/cm³ to form a clay coat layer (3 μm). A silicone layer (0.8 μm) was further formed on each side to obtain a release liner.

(Production of Pressure-Sensitive Adhesive Sheet with Release Liner)

From a double-faced adhesive tape (No. 500, manufactured by Nitto Denko Crop.) were removed the release liners. The release liner produced above was applied to each side of the exposed adhesive layer to thereby produce a pressure-sensitive adhesive sheet with a release liner.

### COMPARATIVE EXAMPLE 2

As a release liner was used SLB-50W-5DP (manufactured by Kaito Chemical Industry Co., Ltd.; the base material layer (fibrous layer) had a thickness of 50 μm, basis weight of 50 g/m², and density of 1.00 g/cm³; with a clay coat layer (thickness, 3 μm) and a silicone layer (0.8 μm) on each side). From a double-faced adhesive tape (No. 500, manufactured by Nitto Denko Corp.) were removed the release liners. The release liner described above was applied to each side of the exposed adhesive layer to thereby produce a pressure-sensitive adhesive sheet with a release liner.

### COMPARATIVE EXAMPLE 3

As a release liner was used SLB-80W-5DP (manufactured by Kaito Chemical Industry Co., Ltd.; the base material layer (fibrous layer) had a thickness of 80 μm, basis weight of 80 g/m², and density of 1.00 g/cm³; with a clay coat layer (thickness, 3 μm) and a silicone layer (0.8 μm) on each side). From a double-faced adhesive tape (No. 500, manufactured by Nitto Denko Corp.) were removed the release liners. The release liner described above was applied to each side of the exposed adhesive layer to thereby produce a pressure-sensitive adhesive sheet with a release liner.

### COMPARATIVE EXAMPLE 4

As a release liner was used SLB-110W-5DP (manufactured by Kaito Chemical Industry Co., Ltd.; the base material layer (fibrous layer) had a thickness of 110 μm, basis weight of 110 g/m², and density of 1.00 g/cm³; with a clay coat layer (thickness, 3 μm) and a silicone layer (0.8 μm) on each side). From a double-faced adhesive tape (No. 500, manufactured by Nitto Denko Corp.) were removed the release liners. The release liner described above was applied to each side of the exposed adhesive layer to thereby produce a pressure-sensitive adhesive sheet with a release liner.

The release liners obtained in the Examples and Comparative Examples given above were examined for the maximum cut resistance force (N/30 mm) imposed on a cutting blade during cutting and for tear strength (N). The results obtained are shown in Table 1.

(Measurement of Maximum Cut Resistance Force)

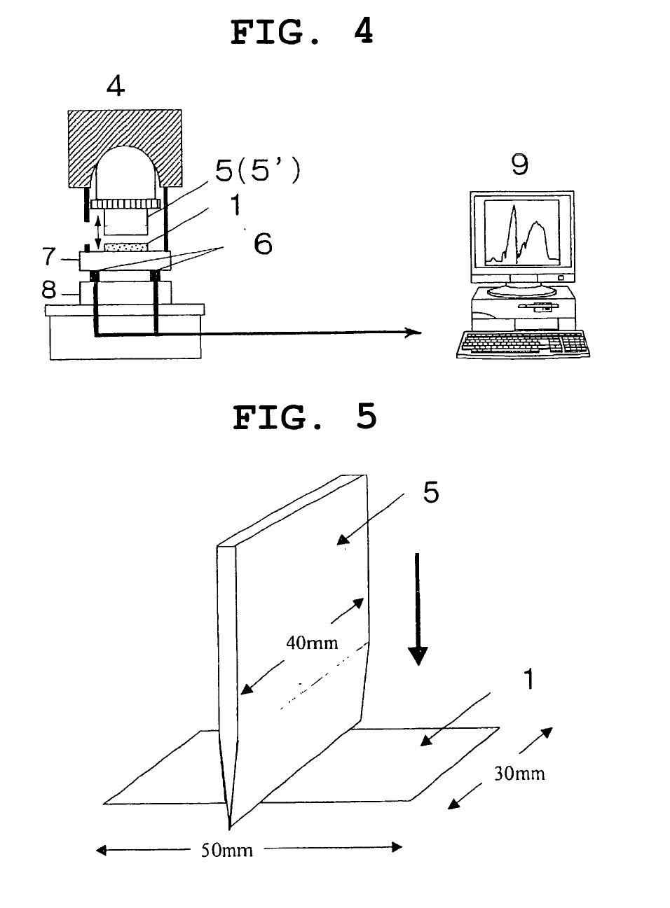

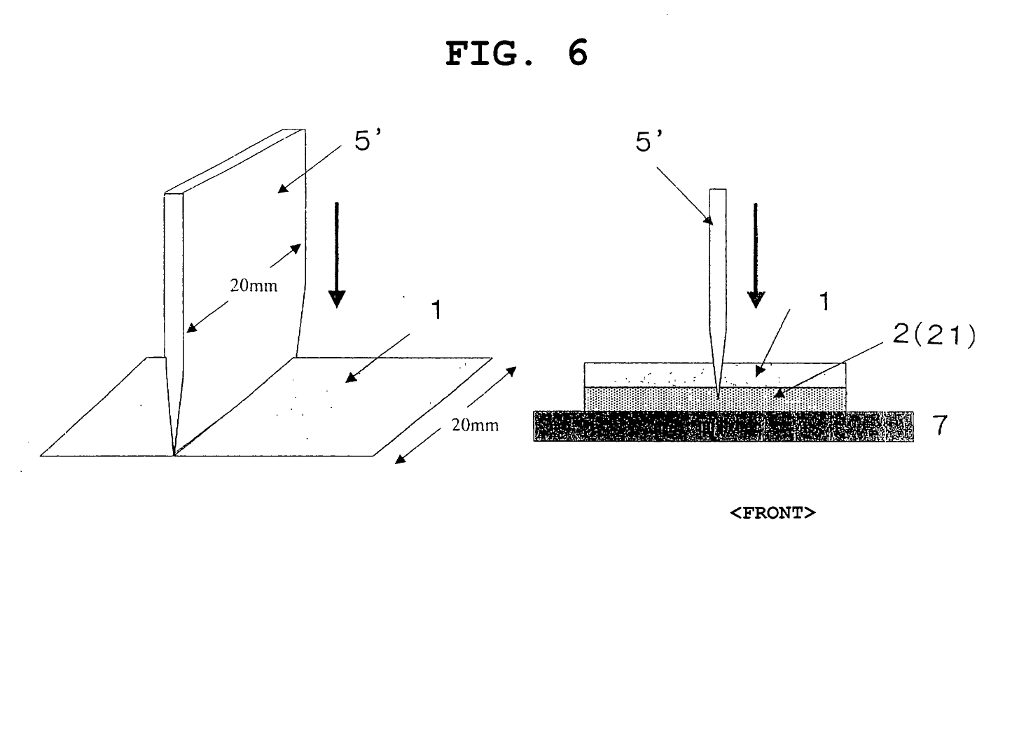

The release liners obtained in the Examples and Comparative Examples were examined with the apparatus shown in FIG. 4 to determine the maximum cut resistance force during cutting. An enlarged view of the cutting part is shown in FIG. 5. The maximum cut resistance force was the average of values obtained when each release liner was cut with a cutting blade in each of the direction perpendicular to the flow direction for the base material layer (fibrous layer) of the release liner and the direction parallel thereto.

The release liner 1 used had a width of 30 mm and a length of 50 mm. The servo pressing mechanism 4 is a hydraulic pressing machine for use in cutting/punching release liners 1. As the cutting blade 5 was used Thomson blade MIR (manufactured by Nakayama K.K.; blade angle, 43°; blade length, 40 mm; blade thickness, 0.71 mm; blade height, 23.6 mm). The stroke frequency was 30 SPM (strokes per minute), and the driving amount was 70 μm based on the face plate level. The measuring apparatus had, disposed between the face plate 7 and a supporting plate 8, a load cell 6 for measuring the cut resistance force imposed on the face plate 7. This load cell 6 has been connected to a personal computer 9. With this apparatus, stress behavior during cutting can be determined (during cutting, the face plate 7 is kept parallel to the upper surface of the pressing machine). The load cell 6 used had the following performances: time resolution, 500 Hz; load resolution, 9 mN; maximum measuring load, 3.6 kN; and withstand load, 27 kN. The temperature was 23° C.

(Measurement of Tear Strength)

The release liners obtained in the Examples and Comparative Examples were examined for tear strength in accordance with JIS P8116 “Tear Strength Testing Method for Paper and Paperboard”. The temperature was 23° C.

The pressure-sensitive adhesive sheets with a release liner obtained in the Examples and Comparative Examples were subjected to the following evaluations. The results obtained are shown in Table 1.

(Method for Evaluating Blade Abrasion)

For the evaluation was used the same apparatus as the cutting apparatus shown in FIG. 4, which was used for the measurement of maximum cut resistance force. One release liner was peeled from each pressure-sensitive adhesive sheet with a release liner, and the pressure-sensitive adhesive layer was applied to the face plate 7. This adhesive sheet was cut by a hundred shots of a cutting blade (razor) 5′. Thereafter, the edge of the blade was examined. Enlarged views of the cutting part are shown in FIG. 6.

The pressure-sensitive adhesive sheet with a release liner 1 had a width of 20 mm. As the cutting blade 5′ used was a single-edged trimming blade (stainless steel; manufactured by Nisshin EM Jirushi K.K.; blade angle, 15°; blade length, 20 mm; blade thickness, 0.25 mm; blade height, 17 mm). The stroke frequency was 30 SPM (strokes per minute), and the driving amount was from 30 to 50 μm based on the pressure-sensitive adhesive layer (regulated so that the lower dead point was located within the pressure-sensitive adhesive layer).

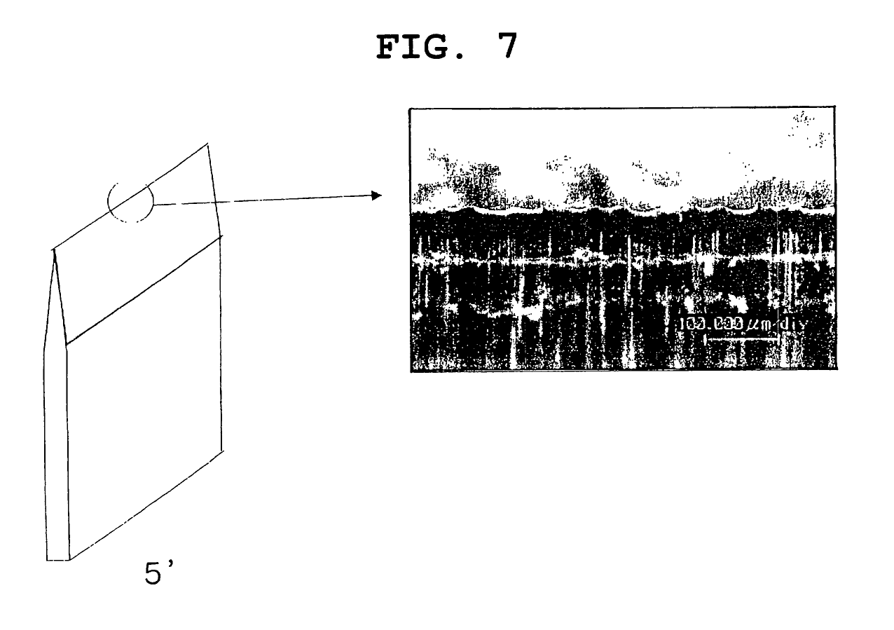

After the cutting, the edge of the razor was examined with a microscope, and blade abrasion was evaluated in terms of the degree of deformation of the edge. Specifically, blade abrasion was evaluated based on the following criteria with respect to the number of deformed parts (depressions) having a length of from 10 to 40 μm which were observed in a 1 mm-wide central part of the razor edge. The number of deformed parts based on which the blade abrasion was evaluated was the average of numbers obtained when the adhesive sheet was cut with the razor in each of the direction perpendicular to the flow direction for the fibrous layer and the direction parallel thereto. A razor used for cutting an adhesive sheet which was rated as X is shown in FIG. 7.

◯: The number of deformed parts is 2 or smaller; blade abrasion is less apt to occur.

Δ: The number of deformed parts is 3 to 9; there are cases where blade abrasion occurs.

×: The number of deformed parts is 10 or larger; blade abrasion occurs frequently.

(Tear Property)

From the results of the measurement of tear strength, tear properties were evaluated based on the following criteria. The tear strength was the average of values obtained when the release liner was torn in each of the direction perpendicular to the flow direction for the fibrous layer and the direction parallel thereto.

TABLE 1

| | | | | Comparative | Comparative | Comparative | Comparative |
|---|---|---|---|---|---|---|---|
| | | Example 1 | Example 2 | Example 1 | Example 2 | Example 3 | Example 4 |
| Release | Maximum cut | 184 | 220 | 280 | 178 | 215 | 246 |
| liner | resistance | | | | | | |
| | force | | | | | | |
| | (N/30 mm) | | | | | | |
| | Tear | 1.18 | 0.67 | 0.78 | 0.39 | 0.59 | 0.98 |
| | strength | | | | | | |
| | (N) | | | | | | |

| | | | | | | |
|---|---|---|---|---|---|---|
| Blade abrasion | ◯ | ◯ | X | ◯ | ◯ | X |
| Tear property of | ◯ | ◯ | ◯ | X | Δ | ◯ |
| release liner | | | | | | |

While the invention has been described in detail and with reference to specific embodiments thereof, it will be apparent to one skilled in the art that various changes and modifications can be made therein without departing from the spirit and scope thereof.

What is claimed is:

1. A release liner which comprises a base material layer and a release agent layer disposed over at least one side of the base material layer, wherein the maximum cut resistance force imposed on a cutting blade when the release liner is cut therewith is 230 N/30 mm or lower and the release liner has a tear strength of 0.6 N or higher.

2. The release liner as claimed in claim 1, wherein the release agent layer has been disposed through a coat layer.

3. The release liner as claimed in claim 1, wherein the base material layer has a density of from 0.3 to 0.85 g/cm³.

4. A pressure-sensitive adhesive sheet with a release liner, wherein the release agent layer of the release liner as claimed in claim 1 has been superposed on the pressure-sensitive adhesive layer of a pressure-sensitive adhesive sheet.
